(19) United States
(12) Patent Application Publication
(10) Pub. No.: US 2012/0035303 A1
(43) Pub. Date: Feb. 9, 2012

(54) NON-BLOOMING FLAME RETARDANT THERMOPLASTIC COMPOSITION

(75) Inventors: Angelika Schmidt, Selfkant (DE); Luc E.F. Leemans, Kortessem (BE); Atze J. Nijenhuis, Sittard (NL)

(73) Assignee: DSM IP Assets B.V., Heerlen (NL)

(21) Appl. No.: 13/147,635

(22) PCT Filed: Feb. 3, 2010
(86) PCT No.: PCT/EP2010/051285

§ 371 Date: Oct. 18, 2011

(30) Foreign Application Priority Data
Feb. 20, 2009 (EP) 09002428.2

(51) Int. Cl. C08K 5/3492; C08K 5/5313

(52) U.S. Cl. 524/100; 524/133

(57) ABSTRACT

This invention relates to a flame retardant thermoplastic composition comprising a thermoplastic polymer composition; a flame retardant containing a phosphorus containing anion; a borate; and an acid scavenger.

This invention relates to non-blooming flame retardant thermoplastic compositions and in particular flame retardant thermoplastic compositions comprising a phosphorus containing anion and a borate compound.

Blooming occurs when an additive has a higher solubility in the polymer at the processing temperature than at ambient temperature. Thereby upon cooling a portion of the additive segregates out of the polymer and, in some instances, migrates to the surface of the polymer.

The problem of blooming is generally addressed by the selection of a different additive or polymer composition, such that the additive is fully soluble at ambient temperature or by reducing the amount of additive usually in combination with the addition of a further additive, whereby the lower concentrations of the two additives are fully soluble in the polymer composition at ambient temperature.

The use of borates, especially zinc borate, especially in halogen free flame retardant polymer compositions, has become increasingly popular. However, it has been found that polymer compositions comprising both a borate and a phosphorus containing anion component are in particular prone to blooming.

Conventionally, the problem of blooming has been addressed by the reduction or substitution of a flame retardant additive. However, this solution can result in a decrease of flame retardant properties of the polymer composition and/or a significant deterioration in mechanical properties.

Therefore, it is an object of the present invention to provide a flame retardant polymer composition which enables borate compounds to be added to the composition without blooming occurring.

This objective is achieved, within the scope of the present invention, by providing a flame retardant thermoplastic composition comprising:

(A) a thermoplastic polymer composition;

(B) a flame retardant comprising a phosphorus containing anion;

(C) a borate; and

(D) an acid scavenger,

Surprisingly, the addition of an acid scavenger (D) is able to reduce or even to eliminate blooming of fire retardant components or derivatives thereof from the total polymer component.

The detection of blooming is performed by visual inspection in which small particle matter is observed on the surface of the polymer. While, the level and extent of blooming may vary, for the purposes of the present invention, blooming is present when visual detection of blooming of any level or extent is detected with the naked eye.

### Component D

An acid scavenger, for the purposes of the present invention, is a compound which neutralizes or binds an acid, thereby preventing the acid reacting with other species within the composition.

Acid scavengers include bronsted bases and/or compounds that are capable of forming an ester with an inorganic acid. Bronsted bases are compounds which accept a hydrogen ion (H⁺) and include neutral bases (eg. NH₃; NH₂OH); Anion bases (eg. H₂PO₄²⁻) and cation bases (eg. [Al(H₂O)₅OH]²⁺).

Examples of suitable acid acceptors include organic compounds like pyridine, triethyl amine, dimethyl aniline. Examples of inorganic acid acceptors are alkali metal oxide, an alkali metal hydroxide, an alkaline earth metal oxide, an alkaline earth metal hydroxide, an inorganic weak base comprising a weak acid and a strong base, an organic hydroxide, an aliphatic amine, an aromatic amine, triazine derivatives, such as melamine or melam, hydrotalcite, carbonates, bicarbonates, stannates, stearates, and ion exchange mediums, such as clays and zeolites. Compounds that are capable of forming an ester with an inorganic acid include oxiranes, oxetanes, thiiranes, carbonates and episulphides. Preferably, the acid scavenger is a bronsted base. Preferred bronsted bases include melamine, talcite, also indicated as hydrotalcite and carbonates, such as calcium carbonate or magnesium carbonate. More preferably melamine or hydro talcite is used, most preferably melamine is used as the acid scavenger.

The acid scavenging equivalent (ASE) is defined as number of moles of acid which may be theoretically (or determined through experimentation) scavenged from a 1 kg of acid scavenger. It will be recognized that, without empirical analysis, the ASE is a theoretically amount due to kinetic and thermodynamic impacts which prevent all the available functional groups on the acid scavengers reacting completely with all the available acid species. As such, the use of an ASE value obtained empirically is preferred. To this extent, the theoretically determined value may be used as a starting point in experimentation to determine the empirical ASE value. It will be appreciated that the ASE value determined empirically for a particular polymer composition may be an order of magnitude different to that determined theoretically. A high ASE is achieved through selecting an acid scavenger with a low molecular weight and a high number of functional groups which can bind or neutralize acid.

Preferably, the acid scavenger has an acid scavenging equivalent of at least 0.5 moles, preferably at least 1.5, more preferably at least 3, more preferably at least 5, more preferably at least 10, even more preferably at least 15 and most preferably at least 20 moles of acid scavenged per kg of acid scavenger. The higher the acid scavenging equivalent of the acid scavenger the less amount of acid scavenger required to prevent blooming. As a consequent, there is a lower risk of the acid scavenger causing a detrimental impact to the functional properties of the composition.

An acid scavenger functional group, for the purposes of the present invention, is a specific chemical group within a compound which is capable of neutralizing or binding an acid. An acid scavenger may have one or more acid scavenger functional groups.

As blooming is a complex phenomena which is dependent upon a variety of compositional and environmental factors, the optimum amount of acid scavenger is best achieved through routine trial and experimentation, in which the polymer composition is processed and cooled under the standard conditions with the proportion of acid scavenger increased until blooming is decreased or eliminated as required. This technique is particularly preferred when the molecular weight of the acid scavenger or the quantity of acid scavenger functional groups can not be determined from a theoretical basis, due to the nature of the acid scavenger (eg. nanoclays or zeolites type materials).

In a special embodiment, the acid scavenger is melamine due to its ability to prevent blooming and contribute toward the fire retardancy of the composition without leading to a significant deterioration, if any, of mechanical properties. Within this embodiment, the amount of melamine is preferably less than 10 wt %, more preferably less than 7 wt %, even more preferably less than 6 wt % and most preferably less than 5 wt % relative to the total weight of the composition.

### Component A

The present invention encompasses polymer compositions (A) which are susceptible to blooming in the presence of phosphorus and borate based flame retardant system.

Very good results are obtained if the polymer composition comprises thermoplastic copolyester elastomers and/or thermoplastic copolyamide elastomers and/or thermoplastic polyurethane elastomers.

Thermoplastic polyurethane elastomers may be obtained by the condensation of diisocyanates with short-chain diols and long chain diols, for example polyester or polyether diols. The polymer chain segments comprising the monomeric units of the diisocyanates and the short-chain diols are the crystalline hard segments and the chain segments derived from the long chain diols are the soft segments. The diisocyanate most commonly used is 4,4′-diphenylmethane diisocyante (MDI). Commonly used short-chain diols include ethylene glycol, 1,4-butanediol, 1,6-hexanediol and 1,4-di-β-hydroxyethoxybenzene.

Thermoplastic copolyester elastomers and/or thermoplastic copolyamide elastomers comprise hard blocks consisting of respectively polyester segments or polyamide segments, and soft blocks consisting of segments of another polymer. Such polymers are also known as block-copolymers. The polyester segments in the hard blocks of the copolyester elastomers are generally composed of repeating units derived from at least one alkylene diol and at least one aromatic or cycloaliphatic dicarboxylic acid. The polyamide segments in the hard blocks of the copolyamide elastomers are generally composed of repeating units from at least one aromatic and/or aliphatic diamine and at least one aromatic or aliphatic dicarboxylic acid, and or an aliphatic amino-carboxylic acid.

The hard blocks typically consist of a polyester or polyamide having a melting temperature or glass transition temperature, where applicable, well above room temperature, and may be as high as 300° C. or even higher. Preferably the melting temperature or glass transition temperature is at least 150° C., more preferably at least 170° C. or even at least 190° C. Still more preferably the melting temperature or glass transition temperature of the hard blocks is in the range of 200-280° C., or even 220-250° C. The soft blocks typically consist of segments of an amorphous or largely amorphous polymer having a glass transition temperature well below room temperature and which temperature may be as low as −70° C. or even lower. Preferably the glass temperature of the amorphous polymer is at most 0° C., more preferably at most −10° C. or even at most −20° C. Still more preferably the glass temperature of the soft blocks is in the range of −20-−60° C., or even −30-−50° C.

Suitably, the copolyester elastomer is a copolyesterester elastomer, a copolycarbonateester elastomer, and/or a copolyetherester elastomer; i.e. a copolyester block copolymer with soft blocks consisting of segments of polyesters, polycarbonate or, respectively, polyether. Suitable copolyesterester elastomers are described, for example, in EP-0102115-B1. Suitable copolycarbonateester elastomers are described, for example, in EP-0846712-B1. Copolyester elastomers are available, for example, under the trade name Arnitel, from DSM Engineering Plastics B.V. The Netherlands. Suitably, the copolyamide elastomer is a copolyetheramide elastomer. Copolyetheramide elastomers are available, for example, under the trade name PEBAX, from Arkema, France.

Preferably, the block-copolymer elastomer in the flame retardant composition is a copolyetherester elastomer.

Copolyetherester elastomers have soft segments derived from at least one polyalkylene oxide glycol. Copolyetherester elastomers and the preparation and properties thereof are in the art and for example described in detail in Thermoplastic Elastomers, 2nd Ed., Chapter 8, Carl Hanser Verlag (1996) ISBN 1-56990-205-4, Handbook of Thermoplastics, Ed. O. Otabisi, Chapter 17, Marcel Dekker Inc., New York 1997, ISBN 0-8247-9797-3, and the Encyclopedia of Polymer Science and Engineering, Vol. 12, pp. 75-117 (1988), John Wiley and Sons, and the references mentioned therein.

The aromatic dicarboxylic acid in the hard blocks of the polyetherester elastomer suitably is selected from the group consisting of terephthalic acid, isophthalic acid, phthalic acid, 2,6-naphthalenedicarboxylic acid and 4,4-diphenyldicarboxylic acid, and mixtures thereof. Preferably, the aromatic dicarboxylic acid comprises terephthalic acid, more preferably consists for at least 50 mole %, still more preferably at least 90 mole %, or even fully consists of terephthalic acid, relative to the total molar amount of dicarboxylic acid.

The alkylene diol in the hard blocks of the polyetherester elastomer suitably is selected from the group consisting of ethylene glycol, propylene glycol, butylene glycol, 1,2-hexane diol, 1,6-hexamethylene diol, 1,4-butane diol, benzene dimethanol, cyclohexane diol, cyclohexane dimethanol, and mixtures thereof. Preferably, the alkylene diol comprises ethylene glycol and/or 1,4 butane diol, more preferably consists for at least 50 mole %, still more preferably at least 90 mole %, or even fully consists of ethylene glycol and/or 1,4 butane diol, relative to the total molar amount of alkylene diol.

The hard blocks of the polyetherester elastomer most preferably comprise or even consist of polybutylene terephthalate segments.

Suitably, the polyalkylene oxide glycol is a homopolymer or copolymer on the basis of oxiranes, oxetanes and/or oxolanes. Examples of suitable oxiranes, where upon the polyalkylene oxide glycol may be based, are ethylene oxide and propylene oxide. The corresponding polyalkylene oxide glycol homopolymers are known by the names polyethylene glycol, polyethylene oxide, or polyethylene oxide glycol (also abbreviated as PEG or PEO), and polypropylene glycol, polypropylene oxide or polypropylene oxide glycol (also abbreviated as PPG or PPO), respectively. An example of a suitable oxetane, where upon the polyalkylene oxide glycol may be based, is 1,3-propanediol. The corresponding polyalkylene oxide glycol homopolymer is known by the name of poly(trimethylene)glycol. An example of a suitable oxolane, where upon the polyalkylene oxide glycol may be based, is tetrahydrofuran. The corresponding polyalkylene oxide glycol homopolymer is known by the name of poly(tretramethylene)glycol (PTMG) or polytetrahydrofuran (PTHF). The polyalkylene oxide glycol copolymer can be random copolymers, block copolymers or mixed structures thereof. Suitable copolymers are, for example, ethylene oxide/polypropylene oxide block-copolymers, (or EO/PO block copolymer), in particular ethylene-oxide-terminated polypropylene oxide glycol.

The polyalkylene oxide can also be based on the etherification product of alkylene diols or mixtures of alkylene diols or low molecular weight poly alkylene oxide glycol or mixtures of the aforementioned glycols.

Preferably, the polyalkylene oxide glycol used in the flame retardant elastomeric composition in the insulated wire according to the invention is selected from the group consisting of polypropylene oxide glycol homopolymers (PPG), ethylene oxide/polypropylene oxide block-copolymers (EO/PO block copolymer) and poly(tretramethylene)glycol (PTMG), and mixtures thereof.

Preferably, at least 50 wt. % of the thermoplastic composition comprises thermoplastic copolyester elastomers and/or thermoplastic copolyamide elastomers and/or thermoplastic polyurethane elastomers, more preferably at least 60wt. %, more preferably 70 wt %, even more preferably at least 80 wt %, still even more preferably at least 90 wt % and most preferably at least 95 wt. %. In a special embodiment the thermoplastic composition consists of thermoplastic copolyester elastomers and/or thermoplastic copolyamide elastomers and/or thermoplastic polyurethane elastomers. Of the thermoplastic copolyester elastomers, the thermoplastic copolyamide elastomers and the thermoplastic polyurethane elastomers preferably the thermoplastic polyester elastomers are used.

A wide variety of other thermoplastic polymers may be included depending upon the functional requirements of the end use application. For instance component A may consist or include polyolefins, polyurethanes or styrenic block copolymers.

In a preferred embodiment, component A comprises a styrenic block copolymer, relative to the total weight of the polymer component in the flame retardant elastomeric composition, in the range of 15 to 40 wt % and more preferably in the range of 20 to 30 wt. %.

Preferred styrenic block copolymers include an acrylonitrile-styrene copolymer (AS), an acrylonitrile-butadiene-styrene copolymer (ABS), a styrene-butadiene-styrene (SBS) copolymer, a styrene-isoprene-styrene (SIS) copolymer, a styrene-ethylene-butylene-styrene (SEBS) copolymer, a styrene-acrylonitrile-ethylene-propylene-ethylidene norbornene copolymer (AES), and a hydrogenated product thereof. Hydrogenated block copolymers include an ethylene/butylene in the midblock (S-(EB/S)-S) and polystyrene-b-poly(ethylene/propylene), polystyrene-b-poly(ethylene/propylene)-b-polystyrene, polystyrene-b-poly(ethylene/butylene)-b-polystyrene and polystyrene-b-poly(ethylene-ethylene/propylene)-b-polystyrene.

Preferably, the styrenic block copolymer is a hydrogenated styrenic block copolymer as this class of compound exhibits excellent UV resistant properties.

Particularly preferred styrenic block copolymers includes, a styrene-ethylene-butylene-styrene (SEBS) copolymer or a styrene-ethylene/propylene-styrene (SEPS). The styrenic block copolymers may be used alone or in combination.

The styrenic block copolymers are preferably grafted with maleic anhydride (MA) or the like onto the copolymer midblock. Typically, between 0.5 to 5.0 wt. % MA, more preferably, 1.0 to 2.5 wt % relative to the total weight of the styrenic block copolymer is grafted onto the block copolymer. The MA grafting improves the adhesion of the copolymer to a variety of substrates including polyamides and polyester.

### Component B

A flame retardant comprising a phosphorus containing anion means, for the purposes of the present invention, one or more fire retardant compound of which at least one comprises a phosphorus anion. Preferably, the phosphorus anion containing compounds represent at least 50 wt % and preferably at least 65 wt % relative to the total weight of component B.

The phosphorus fire retardant preferably comprises a metal salt of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein
R¹ and R² are equal or different substituents chosen from the group consisting of hydrogen, linear, branched and cyclic C1-C6 aliphatic groups, and aromatic groups,
R³ is chosen from the group consisting of linear, branched and cyclic C1-C10 aliphatic groups and C6-C10 aromatic and aliphatic-aromatic groups,
M is a metal chosen from the group consisting of Mg, Ca, Al, Sb, Sn, Ge, Ti, Zn, Fe, Zr, Ce, Bi, Sr, Mn, Li, Na, and K, and
m, n and x are equal or different integers in the range of 1-4, Preferably, component B includes or consists of a nitrogen/phosphorus containing flame retardant which is a reaction product of melamine with phosphoric acid and/or a condensation product thereof. With the reaction product of melamine with phosphoric acid and/or a condensation product thereof are herein understood compounds, which result from the reaction of melamine or a condensation products of melamine are, for example, melem, melam and melon, with a phosphoric acid.

Examples include dimelaminephosphate, dimelamine pyrophosphate, melamine phosphate, melamine polyphosphate, melamine pyrophosphate, melamine polyphosphate, melam polyphosphate, melon polyphosphate and melem polyphosphate, as are described for example in PCT/WO 98/39306. More preferably the nitrogen/phosphor containing flame retardant is melamine polyphosphate.

Also preferably, the nitrogen/phosphor containing flame retardant is a reaction product of ammonia with phosphoric acid or a polyphosphate modification thereof. Suitable examples include ammonium hydrogenphosphate, ammonium dihydrogenphosphate and ammonium polyphosphate. More preferably the nitrogen/phosphorus containing flame retardant comprises ammonium polyphosphate.

Preferably the flame retardant component (B) includes a phosphate compound, more preferably a melamine phosphate compound, most preferably a melamine polyphosphate.

The fire retardant component (B) may be supplemented by other fire retardant compounds which are preferably halogen free. Preferably, the other non-phosphorus fire retardant fire retardant includes a nitrogen containing fire retardant or synergist

Preferably, the nitrogen containing synergist is chosen from the group consisting of benzoguanamine, tris(hydroxyethyl)isocyanurate, allantoine, glycouril, melamine, melamine cyanurate, dicyandiamide, guanidine and carbodiimide, and derivatives thereof.

More preferably, the nitrogen containing synergist comprises a condensations product of melamine. Condensations products of melamine are, for example, melem, melam and melon, as well as higher derivatives and mixtures thereof. Condensations products of melamine can be produced by a method as described, for example, in PCT/WO 96/16948.

Suitable nitrogen containing and nitrogen/phosphor containing compounds are described, for example in PCT/EP97/01664, DE-A-197 34 437, DE-A-197 37 72, and DE-A-196 14 424.

### Component C

The borate or borate precursor may include boron oxides, such as boron trioxide, borax, kernite, colemanite, boronatrocalcite or pandermite. The borate is preferably selected from a group consisting of calcium borate, magnesium borate or zinc borate. More preferably the borate is zinc borate which is a well established fire retardant in polymer compositions.

### Component E

Suitable additives, that can be used in the composition according to the invention are, for example, inorganic fillers, reinforcing agents, pigments, flame retardants, stabilizers, processing aids, impact modifiers, transesterification inhibitors and nucleating agents. The choice of additive, or additives, will depend on the specific polymer composition and the intended application and on the specific properties required, and can easily be chosen by the man skilled in the art of preparing compositions for making products such as moulded parts.

In a preferred embodiment, component (E) represents less than 20 wt % of the total weight of the thermoplastic composition, more preferably less than 10 wt %, even more preferably less than 5 wt. % and most preferably less than 3 wt. % of the total composition. It has been found that the non-blooming compositions of the present invention are particularly advantageous in non-reinforced polymer compositions comprising low proportions of fillers, such as flexible polymer compositions, such as those suitable for flexible cable applications.

### Special Embodiments

In a special embodiment of the present invention, the flame retardant thermoplastic composition comprises:

30 to 88 wt % component (A)

10 to 40 wt % component (B);

0.5 to 15 wt % component (C);

0.05 to 10 wt % component (D); and

0 to 50 wt % component (E);

Component A is preferably 35 to 75 wt % and more preferably 40 to 65 wt % relative to the total weight of the flame retardant composition.

Component B is preferably in the range 15 to 35 wt % and more preferably 20 to 30 wt % relative to the total weight of the flame retardant composition. Preferably, component B comprises a metal salt of phosphinic acid of at least 50 wt % relative to the total weight of component B.

Component C is preferably in the range 1 to 10 wt % and more preferably 1.2 to 5 wt % relative to the total weight of the flame retardant composition. Component C is preferably zinc borate.

Component D is preferably in the range of 0.05-10 wt. %, more preferably 0.1 to 5 wt %, more preferably 0.15 to 4 wt % and most preferably 0.2 to 3 wt % relative to the total weight of the flame retardant composition.

Component E is preferably between 1 and 20 wt %, more preferably between 1.5 and 10 wt % and most preferably between 2 and 5 wt % relative to the total weight of the flame retardant composition. The total amount of additives will dependent upon the ultimate application and the polymers used therein.

### Sample Calculation of Acid Scavenging Equivalent (ASE) Required

The acid scavenging equivalent is defined as the number of moles of acid that 1 kg of acid scavenger can bind/neutralise. For instance: one mole of calcium carbonate is capable of neutralising two moles of acidic protons. The molecular weight is of calcium carbonate is 100 g/mol and therefore the equivalent acid scavenger weight is thus 100/2=50 grams calcium carbonate per mole of neutralized acidic protons or 20 moles of acid may be scavenged per kg of calcium carbonate (acid scavenging equivalent=20 moles/kg).

Sample Calculation of the Theoretical Molar % Acid Scavenger Per Mole of Phosphorus in the Total Composition

This may be illustrated through the calculation used in Example 4. The composition contains 1 wt % calcium carbonates which equates to 0.2 moles of acid which may be scavenged per kilogram of the total composition. The molar amount of phosphorous in the total composition per kilogram can be calculated by summing the phosphorus content in the aluminium diethylphosphinate (23 wt %) (FR-1) and melamine polyphosphate (13 wt %) (FR-2), which works out to be ((0.23×170)+(0.13×90))/31=1.64 moles of phosphorus. Therefore the molar % of acid scavenger relative to phosphorus anions is 0.2/1.64, or about 12 molar % (i.e. molar ratio of (D) to (B) is 0.12).

The polymer composition of the present application is preferably used in the manufacture of a shaped article (e.g. extruded or moulded article). The fire retardant polymer composition has been found to be particularly suited to flexible wires or cables, in which softness, flexibility and surface appearance is required, such as wires and cables used for consumer electronic applications.

Unless other indicated, the % of a component refers to the wt % relative to the total weight of the composition. Thermoplastic means that the composition may repeatedly being molten again upon heating.

### EXAMPLES

### Materials

SEBS: SEBS having a MFI of 7 g/10min (260° C./5 kg), containing in the range of 37-44 wt % styrene and available from Kraton under the trade name A RP6936. (E2, E3 and C7 contain a blend of 75 wt % Kraton A RP6936 and 25wt % Kraton MD6699, a flow improver having a Shore D hardness of 45D also available from Kraton.)
TPE-E: Polyetherester comprising hard segments consisting of polybutyleneterephthalate segments and soft segments consisting of EO/PO polyether blockcopolymer with a shore-D hardness of 38.
FR-1: DEPAL: Aluminium diethylphosphinate containing a phosphorus content of about 23 wt %.; available from Clariant, (Germany) under the brand name (Exolit 1230 or Exolit 930 (Comparative example 3 only)).
FR-2: Melamine polyphosphate containing a phosphorus content of about 12 to 14 wt % available from Ciba, Switzerland under the trade name Melapur™ 200.
Borate: Zinc Borate (2 ZnO₃B₂O₃.3.5H₂O), available from Borax, USA, under the trade name Firebrake™ 500.
Stablizers Blend of auxiliary stabilizer package.
Acid scavenger-1 Ethylene/methyl acrylate/glycidyl methacrylate terpolymer having an acid scavenging equivalent of 0.6 moles of acid per kg (theoretical); an MFI of 6 g/10 min (190° C./2.16 kg) containing 25 wt % acrylate and 8 wt % glycidyl methacrylate sold by Atofina under the brand LOTADER™ AX8900.
Acid scavenger-2 Bisphenol A epoxy resin having an acid scavenging equivalent of 1.7 moles of acid per kg (theoretical) and available from Hexion Specialty Chemicals under the trade name Epicote™ 1055.
Acid scavenger-3 Melamine having acid scavenging equivalent of 7.9 moles of acid per kg (theoretical), available from DSM under the trade name Melafine.
Acid scavenger-4 Magnesium Aluminium Carbonate Hydroxide (hydrotalcite or “talcite”) having an acid scavenging equivalent of about 18 moles of acid per kg (As the exact composition of talcite is not known, the theoretical was determined by titration using a strong acid until a pH of 7 had been reached) and available from Kisuma Chemicals under the trade name DHT 4A™.
Acid scavenger-5 Calcium carbonate having acid scavenging equivalent of 20 moles of acid per kg (theoretical) and a mean particle size of between 40 and 70 nm, available from Solvay Chemicals under the trade name Socal™ 322.
Acid scavenger-6 Cycloaliphatic Epoxide Resin (3,4-epoxycyclohexyl methyl-3,4-epoxy-cyclohexane carboxate) having acid scavenging equivalent of 8.4 moles of acid per kg (theoretical), available from Dow Chemicals under the trade name of ERL4221™
Acid scavenger-7 Aliphatic monoglycidyl ether of C₁₂/C₁₄-fatty alcohol having an acid scavenging equivalent of about 3.2 moles of acid per kg (theoretical) and available from Hexion Specialty Chemicals under the trade name Heloxy™ Modifier Z8.
Acid scavenger-8 Zinc Stannate having an average particle size of between 1.4 and 2.2 microns and available from WillianBlythe under the trade name Flametard S™.
Acid scavenger-9 Montmorillonite modified with a quaternary ammonium salt (nanoclay) available from Rockwood Additives under the trade name Cloiste™ 20A.

### Compounding

For the preparations of moulding compositions, ingredients were compounded in ratios as indicated in Tables 1 to 3. The moulding compositions were prepared by melt-blending the SEBS, TPE-E, with the flame retardant components, stabilizer package and, when present, the acid scavengers on a ZSK 30/34D twin-screw extruder with screw speed of 300 rpm, throughput of 25 kg/hr, and melt temperature regulated at 270° C., extruding the melt from the extruder through a die, and cooling and granulating the melt. The granules obtained by compounding in the extruder were dried for 24 hours at 90° C., prior to further use.

### Moulding of Test Samples and Insulated Cables

Test samples for testing the mechanical properties and the flame retardancy properties according to UL-94-V (1.5 mm thickness) were prepared on an injection-moulding machine of type Engel 80 A. For the injection moulding set temperatures of 235-245° C. were used. The mould temperature was 90° C. Cycle times for the test specimens were about 50 sec.

Insulated cables for testing the flame retardancy properties according to UL 1581 VW-1 were prepared on an industrial production line under comparable operating conditions at a speed of between 50 to 100 m/min. The cables thus produced included:

### Test Methods

### Blooming

The blooming test is performed in a climate controlled chamber such that the temperature and relative humidity can be regulated separately. Each test sample was placed in a perforated polyethylene bag (100 mm×150 mm, with 40 holes of approximately 5 mm diameter (4 rows of 5 holes) placed in the middle portion of each side of the bag.) The perforated bags function to ensure that the test samples were exposed to an air velocity of less than 0.01 m/sec and more preferably less than 0.001 m/sec. Material samples (tensile strength test bars) were placed in the climate controlled chamber under environmental conditions of 30° C. and a relative humidity at 70%. At daily intervals, the samples were inspected for blooming, with the time to the first onset of blooming recorded. After 14 days storage under these conditions the sample were visually inspected with the naked eye for signs of blooming. Samples were deemed to be non-blooming if no visual signs of blooming were detected after this 14 day period. The presence of blooming is denoted by visual evidence of surface discoloration or the deposition of precipitated material characteristic of blooming events.

Example 5 (E-5), a duplicate of comparative experiment 8 (CE-8) was also tested for blooming under milder atmospheric conditions (23° C. and a relative humidity of 50% for 14 days).

### Mechanical Properties

Tensile strength and the retention of the % elongation at break after 168 hr at 121° C. was performed according to ISO 527/1A using dry-as-moulded samples, with the tensile test specimens having a thickness 4 mm.

### Flame Retardancy

Sample preparation and testing was performed according to UL1581 VW-1.

### Calculation of the Amount of Required Acid Scavenger Equivalent (ASE) to Prevent Blooming

The test samples for comparative experiments, CE-1 to CE3 and examples E1 and E2 were prepared having a composition as provided in Table 1.

TABLE 1
Polymer composition (wt %) of samples used to determined
required amount of acid scavenger

| | CE-1 | CE-2 | CE-3 | E-1 | E-2 |
|---|---|---|---|---|---|
| TPE-E | 38.5 | 38.5 | 38.5 | 38.5 | 38.5 |
| SEBS | 30 | 30 | 30 | 30 | 30 |
| FR-1 (DEPAL) | 18.5 | 18.5 | 18.5 | 18.5 | 18.5 |
| FR-2 (MPP) | 10 | 10 | 10 | 10 | 10 |
| Borate | 1.5 | 1.5 | 1.5 | 1.5 | 1.5 |
| Additives | 1.15 | 1.05 | 0.95 | 0.75 | 0.5 |
| Acid scavenger 4 | 0.35 | 0.45 | 0.55 | 0.75 | 1.0 |

The test samples were stored at 30° C. and 70% relative humidity for 14 days in an atmospherically controlled chamber. The samples were visually inspected for blooming after 14 days, with the results displayed in Table 2. It was determined that at least about 4.2 grams of the acid scavenger per 1 mole of phosphorus anion in the total composition is required to prevent blooming. Within the phosphorus anion containing fire retardants, one mole of phosphorus anion theoretically equates to the formation of one mole of acid. As the amount of acid scavenger is less than 40 wt % above the minimum amount to prevent blooming (i.e. if actual minimum is just above 3.1 grams of DHT 4A™ per mole of phosphorus/acid (CE-3)), no further testing was deemed necessary. Therefore, the experimentally determined ASE was 238 moles of acid are neutralized/bound per 1 kg of talcite (DHT 4A™). This is about 13 times the theoretical amount of acid scavenger required to neutralize all acid in the composition. The difference between the experimental and theoretical value is due to the fact only a portion of the acid may need to be neutralized to prevent blooming.

It is noted that the experimental value of the amount of acid scavenger required could have also of been derived though an iterative process of adjusting the ratios of acid scavenger (D) to flame retardant (B) of each sample.

TABLE 2
Example of a sample screening technique used to determine
minimum amount of required acid scavenger component.

| | grams of DHT 4A ™ per | |
|---|---|---|
| Test sample | mole of phosphorus (acid). | Blooming |
| CE-1 | 2.0 | Yes |
| CE-2 | 2.5 | Yes |
| CE-3 | 3.1 | Yes |
| E-1 | 4.2 | No |
| E-2 | 5.6 | No |

The results of blooming and mechanical properties of a variety of compositions are provided in Table 3. The table highlights that, in addition to talcite, melamine, cycloaliphatic epoxide resin and under milder atmospheric conditions, calcium carbonate may be employed in formulations to eliminate blooming. Preferably, talcite or melamine is used as an acid scavenger due to their ability to eliminate blooming without a substantial decrease in mechanical and/or fire retardant properties.

Further observations which may be drawn from Table 3 include:
A comparison of CE-4 and CE-5 reveals that the borate compound contributes to blooming.
A comparison of CE-6, CE-7 and CE-9 reveals that a molar % of acid scavenger equivalent to phosphorous of less than 2% does not eliminate blooming;
A comparison of CE-8 and E-5 reveals that the occurrence of blooming is dependant upon the atmospheric conditions in which the test sample is exposed to. Therefore, a non-blooming composition may be tailored to a specific end use; and
A comparison of CE-4, CE-10 and CE-11 reveals that the replacement of zinc borate with zinc stannate eliminates blooming, but results in deterioration in heat aging and fire retardant properties. It is noted that the while CE-10 and CE-11 passed the UL1581 VW-1 test, observations during the test indicated that it was a borderline pass, with the flame height being substantially higher than flame height observed with CE-4.

TABLE 3
Blooming and mechanical properties of polymer compositions

| | CE-4 | CE-5 | CE-6 | CE-7 | CE-8 | CE-9 | CE-10 | CE-11 | E3 | E4 | E5 |
|---|---|---|---|---|---|---|---|---|---|---|---|
| TPE-E | 41.5 | 41.5 | 41.5 | 40.5 | 40.5 | 40.5 | 47.4 | 38.5 | 41.5 | 40.5 | 40.5 |
| SEBS | 30 | 30 | 25 | 30 | 30 | 30 | 25 | 30 | 30 | 30 | 30 |
| FR-1 (DEPAL) | 17 | 18 | 17 | 17 | 17 | 17 | 15.8 | 18 | 17 | 17 | 17 |
| FR-2 (MPP) | 9 | 9 | 9 | 9 | 9 | 9 | 7.9 | 9 | | 9 | 9 |
| Borate | 1.4 | | 1.4 | 1.4 | 1.4 | 1.4 | | | 1.4 | 1.4 | 1.4 |
| Additive package | 1.1 | 1.5 | 1.1 | 1.1 | 1.1 | 1.1 | 2.6 | 1.5 | 1.1 | 1.1 | 1.1 |
| Acid scavenger-1 | | | 5 | | | | | | | | |
| Acid scavenger-2 | | | | 1 | | | | | | | |
| Acid scavenger-3 | | | | | | | | | 4 | | |
| Acid scavenger-5 | | | | | 1 | | | | | | 1 |
| Acid scavenger-6 | | | | | | | | | | 1 | |
| Acid scavenger-7 | | | | | | 1 | | | | | |
| Acid scavenger-8 | | | | | | | 1.3 | | | | |
| Acid scavenger-9 | | | | | | | | 3 | | | |
| Mole % ASE./P | 0 | 0 | 1.8 | 1.0 | 12 | 1.9 | | | 21 | 4.9 | 12 |
| Blooming (onset-days) | Y(1) | No | Y(2) | Y(2) | Y(1) | Y(2) | No | No | No | No | No |
| Ten strength MPa | 9.1 | 8.6 | 9.5 | 8.5 | 8.8 | 7.6 | 10.1 | 8.0 | 9.0 | 6.4 | 8.8 |
| % | 96 | 90 | 96 | 96 | 100 | 95 | 84 | 83 | 100 | 89 | 100 |
| Elongation@121° C./168 hr | | | | | | | | | | | |
| UL1581 VW-1 | 5/5 | 5/5 | 4/5 | 5/5 | 5/5 | 5/5 | 5/5 | 5/5 | 10/10 | 4/5 | 5/5 |

* initial elongation 28%.

1. A flame retardant thermoplastic composition comprising:
(A) a thermoplastic polymer composition;
(B) a flame retardant comprising a phosphorus containing anion;
(C) a borate; and
(D) an acid scavenger.

2. Composition according to claim 1, wherein the borate (C) comprises zinc borate.

3. Composition according to claim 1, wherein the acid scavenger (D) comprises a bronsted base.

4. Composition according to claim 1, wherein the bronsted base is selected from a group consisting of melamine, calcium carbonate and/or talcite.

5. Composition according to claim 1, wherein component (A) comprises a thermoplastic copolyester elastomer and/or a thermoplastic copolyamide elastomer and/or a thermoplastic polyurethane elastomer.

6. Composition according to claim 1, wherein component (A) contains a styrenic block copolymer.

7. The composition according to claim 1, wherein the composition comprises:
30 to 88 wt % component (A)
10 to 40 wt % component (B);
0.5 to 15 wt % component (C);
0.05 to 10 wt % component (D); and optionally
0 to 50 wt % component (E).

8. Composition according to claim 1, which composition contains 0.1-5 wt. % of the acid scavenger.

9. A shaped article comprising the composition of claim 1.
